(19) United States
(12) Patent Application Publication
(10) Pub. No.: US 2002/0133362 A1
(43) Pub. Date: Sep. 19, 2002

(54) Computerized dispute resolution system

(76) Inventors: Elliot Karathanasis, Hoboken, NJ (US); Louis R. Pizante, New york, NY (US); Kerry A. Kennedy, New york, NY (US)

Correspondence Address: Elliot Karathanasis, Esq., I'M RIGHT YOU'RE WRONG,LLC, 36 West 25th street, 8th Floor, New York,, NY, 10010, US

(21) Appl. No.: 09/804,948

(22) Filed: Mar. 13, 2001

(51) Int. Cl. G06F 17/60

(52) U.S. Cl. 705/1

(57) ABSTRACT

A method for dispute resolution comprises the steps of receiving on a server a plurality of users connected to the server via a communications network, engaging, upon notification of a dispute by a first one of the users, software guiding the first user through procedures for initiating the dispute resolution process, wherein the software gathers plaintiff information from the first user corresponding to the dispute and receiving from the first user a first proposed a rule governing behavior in situations corresponding to the dispute in combination with the steps of notifying a second one of the users identified by the first user as a party to the dispute of the initiation of the dispute resolution process, soliciting from the second user defendant data corresponding to the dispute and one of a second proposed rule governing behavior in situations corresponding to the dispute and proposed modifications to the first proposed rule and determining a result of the dispute resolution process based upon the plaintiff data, the defendant data, the first proposed rule and the one of the second proposed rule and the proposed modifications to the first rule.

### FIELD OF INVENTION

The current invention relates to methods and systems for dispute resolution.

### BACKGROUND

Current methods for resolving disputes such as legal proceedings, arbitration, and mediation are unattractive to a large number of people and/or unsuitable to a wide range of disputes due to their intricacies, costs, and the long periods of time required to arrive at decisions. For example, these proceedings may require participants to travel to examine witnesses and/or documents and to personally participate in proceedings, entailing scheduling difficulties, travel time and costs, etc.

Furthermore, the formality of these proceedings may discourage users from employing them in a wide range of situations.

### SUMMARY OF THE INVENTION

The present invention is directed to a method for dispute resolution comprising the steps of receiving on a server a plurality of users connected to the server via a communications network and engaging, upon notification of a dispute by a first one of the users, software guiding the first user through procedures for initiating the dispute resolution process, wherein the software gathers plaintiff information from the first user corresponding to the dispute in combination with the steps of receiving from the first user a first proposed rule governing behavior in situations corresponding to the dispute, notifying a second one of the users identified by the first user as a party to the dispute of the initiation of the dispute resolution process, soliciting from the second user defendant data corresponding to the dispute and one of a second proposed rule governing behavior in situations corresponding to the dispute and/or proposed modifications to the first proposed rule and determining a result of the dispute resolution process based upon the plaintiff data, the defendant data, the first proposed rule and the one of the second proposed rule and the proposed modifications to the first rule.

The present invention is further directed to a system for resolving disputes comprising a server accessible to a plurality of users via a communications network, the server including a processor executing case management software upon notification of a dispute by a first one of the users, the case management software guiding the first user through procedures for initiating the dispute resolution process, wherein the case management software gathers plaintiff information from the first user corresponding to the dispute and receives from the first user a first proposed rule governing behavior in situations corresponding to the dispute and a communications arrangement notifying a second one of the users identified by the first user as a party to the dispute of the initiation of the dispute resolution process and soliciting from the second user defendant data corresponding to the dispute and one of a second proposed rule governing behavior in situations corresponding to the dispute and proposed modifications to the first proposed rule providing a forum through which one or more of the plurality of users may adjudicate the dispute based upon the plaintiff data, the defendant data, the first proposed rule and the one of the second proposed rule and the proposed modifications to the first rule.

### BRIEF DESCRIPTION OF THE DRAWINGS

FIG. 1 shows a network employing an exemplary dispute resolution system according to the present invention;

FIG. 2 shows a server on which the dispute resolution system according to the invention may be run;

FIG. 3 shows an exemplary first data storage device for use in accord with the system of FIG. 1;

FIG. 4 shows a flow chart indicating the procedure for registering with the system according to the present invention;

FIG. 5 shows a flow chart indicating the procedure by which a user (plaintiff) initiates a dispute resolution process according to the invention;

FIG. 6 shows a flow chart indicating the procedure by which the plaintiff indicates desired decision-making parameters;

FIG.7A shows a first part of a flow chart indicating the procedure by which additional parties to the dispute (e.g., defendants) are brought into the dispute resolution process;

FIG. 7B shows a second part of the flow chart of FIG. 7A;

FIG. 8 shows a flow chart indicating a witness participation procedure according to the present invention;

FIG. 9 shows a flow chart indicating a panelist participation procedure according to the present invention; and

FIG. 10 shows a flow chart indicating an observer participation procedure according to the present invention.

### DETAILED DESCRIPTION

An automated system according to the present invention is illustrated for managing an online, trial-like or arbitration-like dispute resolution process including preliminary pleadings and discovery. The system includes, among other things, a search engine, secured management software, an accessible database of templates for legal pleadings, an accessible database of case specific information, and a step-by-step procedure for collecting and organizing personal information pertinent to the case file and a database of archived cases for use as precedents and a jury or panel system for rendering decisions. In the figures, like elements will be provided with the same reference numerals.

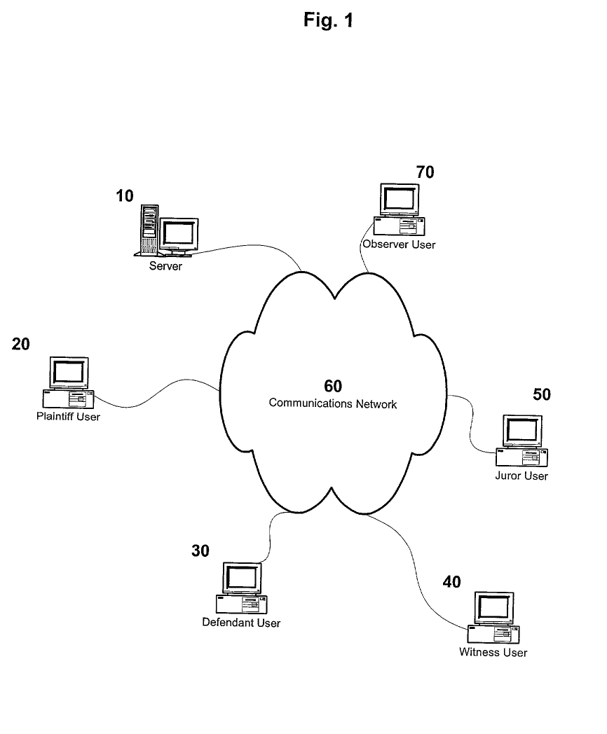

FIG. 1 shows a communications network 60 employing an exemplary embodiment of a system according to the present invention, which provides a real time forum for multiple parties to participate in a dispute resolution proceeding. This system allows for various users to exchange data with a server 10 via the communications network 60 which may be, for example, the Internet, a local area network (LAN), a wide area network (WAN), an intranet, etc. The users may include for example, a plaintiff 20, a defendant 30, witnesses 40, panelists 50 and observers 70 at separate computers coupled to the communications network 60. The panelists 50 maybe a jury selected as specified below or a panel of arbitrators having particular expertise or experience specified by the parties in a manner similar to that employed in the selection of a custom panel (described below). The process for arbitration will be identical to that of the below-described dispute resolution processes employing a jury (including the jury deliberation and voting processes) except for the substitution of a panel of selected arbitrators for jurors. In the exemplary embodiment described herein, the procedure is an automated process resembling the structure of civil trials or arbitration proceedings in the United States. However, those skilled in the art will understand that the same automating and data management structures may be implemented in a wide variety of arrangements to provide dispute resolution procedures resembling various existing processes or ones which are completely new. Furthermore, although the exemplary embodiment is described as operating on a central server with a plurality of users coupled thereto via a communications network, those skilled in the art will understand that a system according to the present invention may be implemented as a peer-to-peer system where the required software is resident on individual user computers which communicate directly with one another to participate in a dispute resolution process. It is also possible for all of the software running such a system to be run on a single user computer which accommodates all of the users (e.g., plaintiff 20, defendant 30, witnesses 40 and panelists 50).

The plaintiff 20 initiates the dispute resolution procedure by contacting the server 10 and registering with the system, after which the plaintiff 20 may prepare and file a complaint with the assistance of the case wizard software described in more detail below which asks questions to bring out the relevant facts. The complaint is then forwarded to the defendant 30 for an answer by, for example, electronic mail (“email”) which defendant 30 may then answer by accessing the case wizard software 147. Both parties may propose a rule or rules which they believe should govern behavior in the disputed situation and may present witnesses 40 to corroborate or explain the circumstances surrounding the dispute. Furthermore, any of the parties (plaintiff 20, defendant 30 or witnesses 40) may submit evidence to support their claims. For example, photographs or documents may be submitted in electronic format. These documents will then be stored by the case wizard software 147 in the corresponding case specific database 133′ and the case wizard software 147 will then post these documents in a location accessible to the parties as well as the panelists 50 who will judge the dispute and any observers 70.

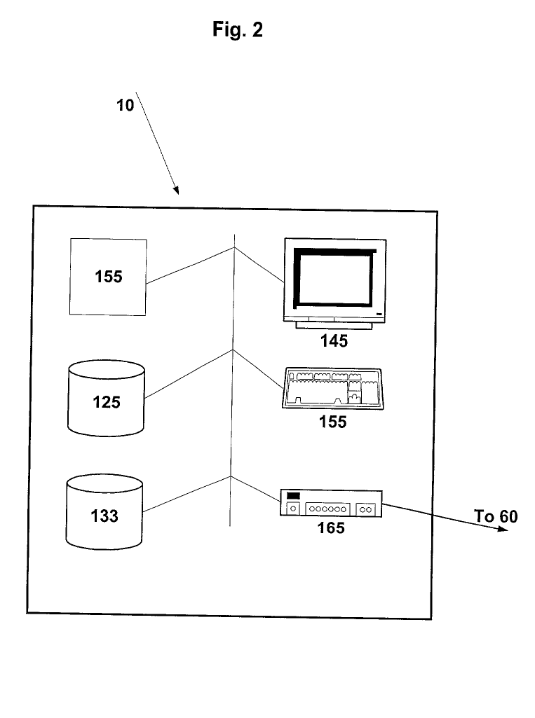

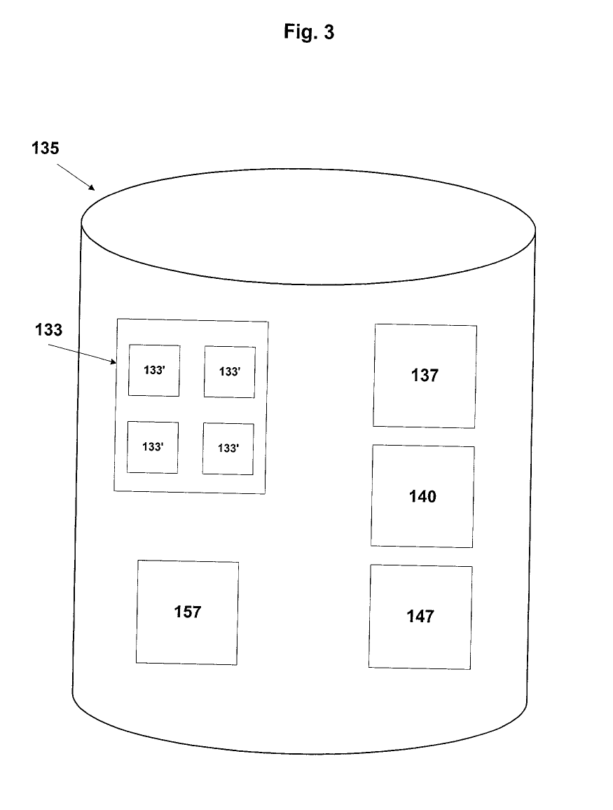

As shown in FIG. 2, an exemplary embodiment of the server 10 may include a processor 115, a first storage device 125 (e.g. RAM), a second storage device 135 (e.g. a hard drive), an output arrangement 145, an input arrangement 155, and a communications device 165. The processor 115 manages the flow of data through the system and the first storage device 125 holds this data while it is processed by the processor 115. The second storage device 135 may store a plurality of databases (e.g., a case database 133 including a plurality of case specific databases 133′, a template database 137, a database of prior cases, a database of potential panelists, etc. as shown in FIG. 3), as well as software applications (e.g., applications for operating personal computing devices such as DOS, Windows, Linux, Unix, etc.). These software applications may provide a graphical user interface allowing remote users to request and view data via the communications network 60. The output arrangement 145 may include a monitor, audio speakers, a printer, and/or a disk drive operatively connected to the processor 115, while the input arrangement 155 may include a keyboard, a mouse, and/or a disk drive, operatively connected to the processor 115. The communications device 165, which may be a network card, a modem, or any other communications device capable of modulating and demodulating signals, is provided to allow users to access the server 10 via the communications network 60.

As is known in the art, the computer which a user uses to connect to the server 10 via the communications network 60 may include a processor, a first storage device (e.g.

RAM), a second storage device (e.g. hard drive), input and output devices (e.g., keyboard and monitor), and a communications device. The processor 110 analyzes data and runs software applications that operate the user computing device (e.g. DOS, Windows, Linux, etc.) and provide a graphical user interface permitting the user to request and view data. Those skilled in the art will understand that users may also connect to the communications network 60 via devices other than traditional computers (e.g., internet appliances, embedded devices, personal digital assistants (PDAs), WebTV, telephones, etc.).

As described above, the server 10 may be connected to a plurality of user computers (e.g., plaintiff 20, defendant 30, etc.) via the communications network 60. The server 10 employs software for accepting remote user connections as well as database management software which may, for example, be stored in data storage device 135. This software may include a case database 133 including a plurality of case specific databases 133′, a template database 137, a user database 140, case wizard software 147 and a search engine 157 with the operation of each of these software components being described in greater detail below.

Referring to FIG. 3, the case wizard software 147 manages the creation, revision, and maintenance of user personal records in the case specific databases 133′, and templates in the template database 137 and controls the sequence and timing of the various steps in the dispute resolution process. For example, the case wizard software determines the order and timing in which the various templates of a complaint are presented to the plaintiff 20, the defendant 30 and other participants in the dispute resolution process. The case wizard software 147 may, for example, store a sequence and timing of events for each of a plurality of dispute resolution processes and include a corresponding list of inquiries which assist parties in providing a clear and comprehensive version of the facts. For each case, one of these stored sequence and timing files will be selected based on the details of the particular case. In addition, the case wizard software 147 may include a plurality of criteria which are compared to the case specific data (described below) in order to select the particular sequence and timing of events most suitable to a particular dispute. Specifically, the case wizard software 147 utilizes the selected sequence and timing in order to provide templates including inquiries to users which guides the users through the process of creating the documents required of them during the various stages of the dispute resolution process. As will be understood by those skilled in the art, the logical operations of the case wizard software 147 may be implemented through commercially available software applications, for example, database management systems. The search engine 157 handles queries directed by the case wizard software 147 to, for example, the template database 137 and the case database 133 and the case specific databases 133′. This search engine 157 is used by the processor to find templates, case specific information, timing sequence data or precedents as directed by the case wizard software 147.

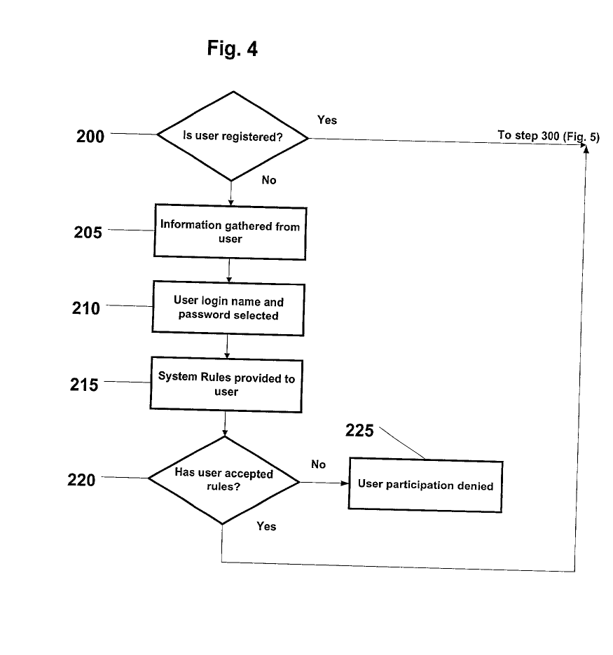

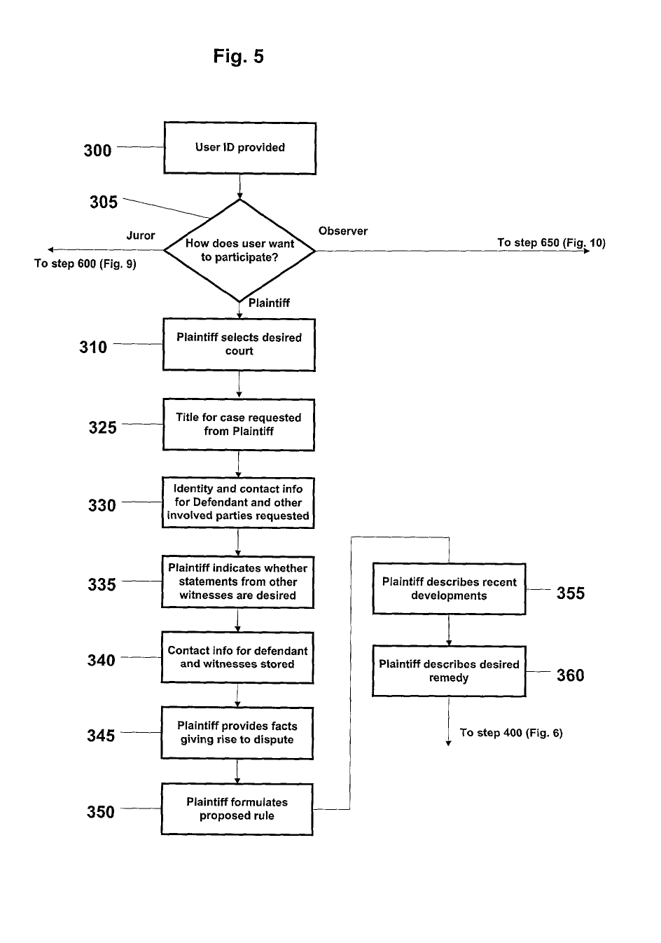

For example, as shown in FIG. 4, when a user indicates that he wishes to participate in a dispute resolution proceeding, the case wizard software 147 first determines in step 200 whether the user is registered with the system. If the user is already registered, the process moves to step 300 of FIG. 5 wherein the user indicates in which manner he would like to participate in a dispute resolution proceeding. If the user has not previously registered, the case wizard software requires the user to register with the system before proceeding using steps 205-220. In step 205 of the registration process, the user provides to the server 10 information including, for example, identity, contact information, demographic data, etc. which is stored in the users database 140. Thereafter, in step 210, the user chooses a login name and password which is also stored in the users database 140. After this, in step 215, the case wizard software 147 provides to the user the rules of the system and, in particular, the applicable rules of the dispute resolution system. The user is then required in step 220 to accept these rules before participating in dispute resolution proceedings. If the user accepts the rules, the process moves to step 300 of FIG. 5. If the user does not accept the rules, the registration process is ended in step 225.

FIG. 5 shows the process by which a registered user initiates participation in a dispute resolution proceeding. First, in step 300, the user identifies himself to the system and, in step 305, the user is asked by the system in what way he would like to participate. The user may be provided in this step with menus listing the various options (e.g., plaintiff, panel member, observer, participate in deliberation regarding a case, etc.). If the user selects “plaintiff” in step 305, in step 310 the case wizard software 147 asks that the plaintiff 20 select an appropriate court for this dispute resolution proceeding based on factors such as the relationship between the parties to the dispute and the subject matter of the dispute. For example, the plaintiff 20 may be asked to select from a list of courts including Lovers' Court, Friends' Court, Roommates' Court, Ex's Court, Family Court, Neighbors' Court, Co-Workers' Court or Plea Bargain. With the exception of Plea Bargain, procedure in each of the courts is identical and these courts differ only in the types of disputes hosted there. Plea Bargain operates in the same way as the other courts except that the plaintiff 20 is admitting culpability and asking only for a decision from the jury or panel that will determine the manner in which he should make up this wrong.

In step 325, the plaintiff 20 is asked to supply a title summary for the dispute resolution proceeding. In step 330, the case wizard software 147 requests the identity of the defendant 30 along with the defendant's contact information (e.g., email address) and relation to the plaintiff 20 as well as the identity and email address for any other party involved in the dispute resolution proceeding. The case wizard software 147 then asks in step 335 whether the plaintiff 20 wishes to have other involved parties make statements.

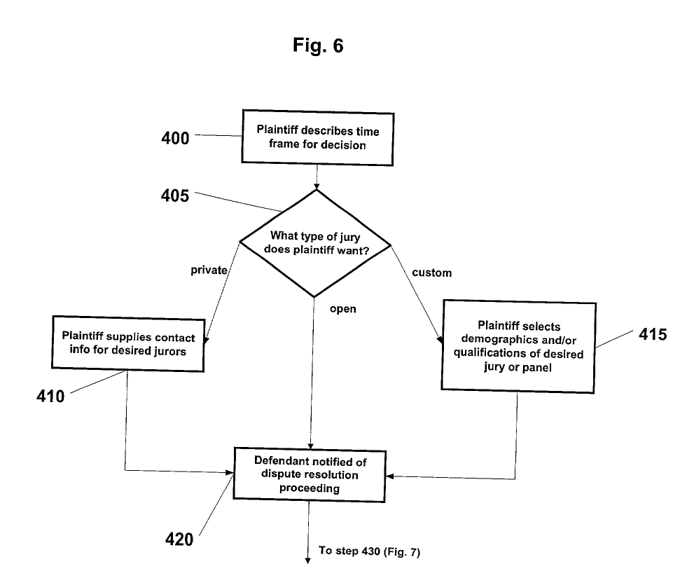

Thereafter, the case wizard software 147 stores the contact information (e.g., email address) for the defendant 30 and any other involved parties in the corresponding case specific database 133′ in step 340. The process then proceeds to step 345 in which the plaintiff 20 is requested to provide the facts giving rise to the dispute and any additional information which may help his case. In step 350 the plaintiff 20 is asked to formulate a rule which he feels should govern behavior in situations such as that which gave rise to the present dispute. Alternatively, the case wizard software 147 may present either or both of the plaintiff 20 and the defendant 30 with a suggested rule or a set of suggested rules which either party may adopt or modify as desired. These proposed rules may, for example, include rules proposed in the past by parties to similar disputes. The case wizard software 147 then asks the plaintiff 20 in step 355 to describe any recent developments in the situation. All of the information provided by the plaintiff 20 is stored in the corresponding case specific database 133′. The plaintiff 20 is then asked in step 360 to specify a remedy for the situation and may be provided with suggested remedies listing, for example, monetary damages, a gift, an apology, specific performance, etc. Thereafter, the process proceeds to step 400 of FIG. 6.

As shown in FIG. 6, in step 400, the case wizard software 147 queries the plaintiff 20 for information regarding a time frame within which a decision is desired. Of course, as will be understood by those skilled in the art, the time frames within which a decision may be made may vary depending on the type of jury or panel requested or selected in the case. Thereafter, in step 405, the plaintiff 20 is asked to select a type of jury or panel which he would like to have decide this dispute resolution proceeding. For example, the plaintiff 20 may indicate that anyone who wishes to can vote (an open jury) or that a custom designed panel (selected based on demographic and psychographic data as described below) should hear the case. If the plaintiff 20 selects an open jury, the process proceeds directly to step 420 (described below). Alternatively, the plaintiff 20 may choose a private panel and identify a list of panelists in step 410 (including the email addresses of the potential panelists) that he wants to try the case.

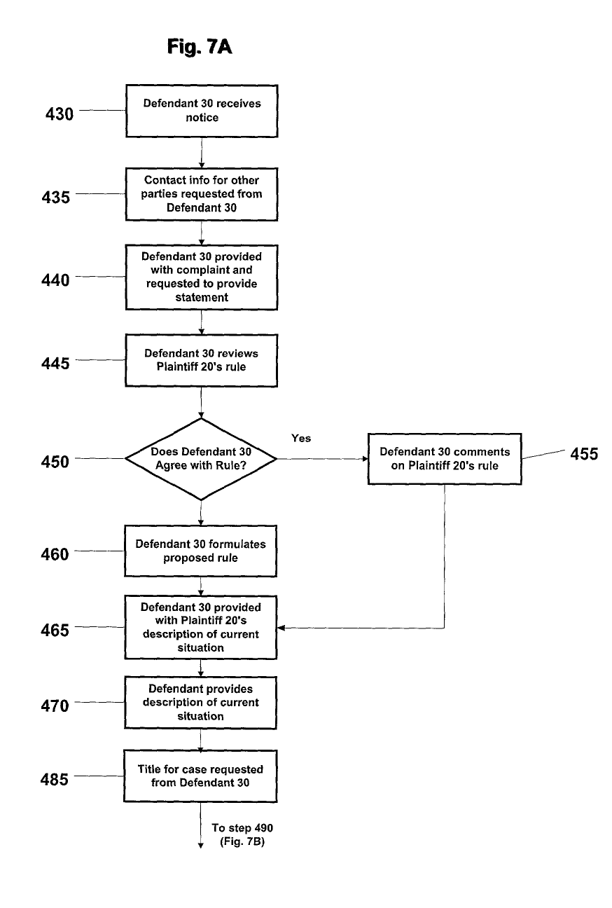

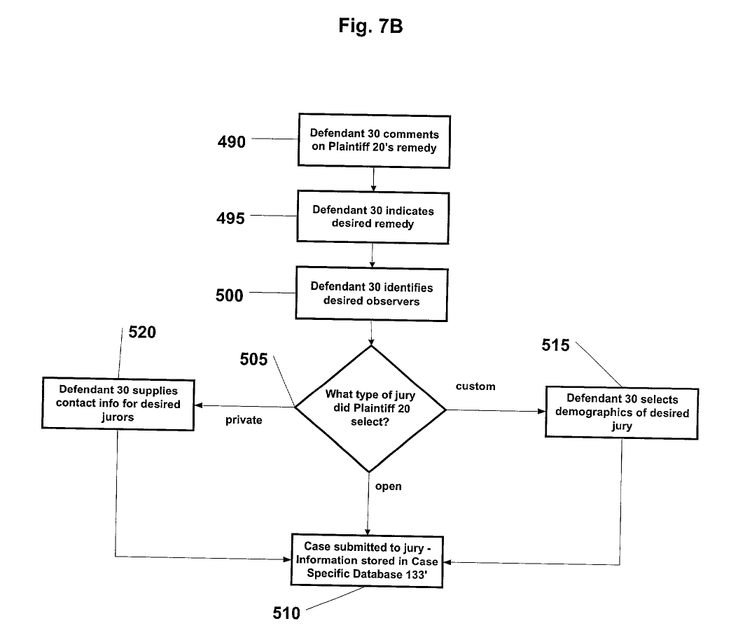

If the plaintiff 20 chooses a custom designed panel, in step 415 the case wizard software 147 will query the plaintiff 20 for information regarding the characteristics of desired panelists. The plaintiff may be asked to specify demographic criteria which the panelists 50 should meet including, for example, data regarding age, profession, education level, experience with similar or related situations, etc. Specifically, depending on the facts of a given case, a plaintiff 20 may specify that panelists 50 should be dentists with more than 5 years of experience in addition to other criteria. Once this information has been submitted by the plaintiff 20 and confirmed accurate, the information is stored in the corresponding case specific database 133′ and can no longer be amended by the plaintiff 20. In step 420, an email is then sent to the defendant 30 notifying him of the plaintiff 20's submission and the process proceeds to step 430 of FIG. 7.

Referring to FIGS. 7A and 7B, in step 430 the defendant 30 receives the communication including a link to the dispute resolution proceeding. The link takes the defendant 30 to a page listing all of the parties which the plaintiff 20 indicated were involved and, in step 435 asks the defendant 30 to provide contact information for anyone else who was involved and to indicate whether the defendant 30 would like any of them to make a statement. At this point, the defendant 30 may also be given an opportunity to change his contact information to, for example, a more convenient email address. Thereafter, in step 440, the case wizard software 147 provides to the defendant 30 the plaintiff 20's claims and requests a statement of the defendant 30's position on the facts. In step 445, the case wizard software 147 provides the plaintiff 20's proposed rule and asks in step 450 whether or not the defendant 30 agrees with the rule. If the defendant 30 agrees with the plaintiff 20's proposed rule, in step 455 the case wizard software 147 asks the defendant 30 to comment on the proposed rule. For example, the defendant 30 may indicate that, although he agrees with the plaintiff 20's proposed rule, the rule does not govern this dispute because of certain facts or circumstances which he may then set forth. If the defendant 30 does not agree with the plaintiff 20's proposed rule, in step 460, the defendant 30 is asked to make up his own proposed rule and is offered the opportunity to supply reasons in support of his proposed rule or indicating why the plaintiff 20's proposed rule should not be applied to these facts. Then, in step 465 the case wizard software 147 provides to the defendant 30 the plaintiff 20's statement on the current situation and, in step 470, asks the defendant 30 for his statement of the current situation. Then, in step 485 the defendant 30 is asked to provide a title summarizing the dispute. Then in step 490 the defendant 30 is shown what remedy the plaintiff 20 has requested and to provide his thoughts on this remedy (i.e., will the defendant 30 consider granting this request). The defendant 495 is then asked to indicate what remedy he would like if the panel decides in his favor. In step 500, the defendant 30 is asked to provide contact information for anyone he would like to observe this dispute resolution proceeding and in step 490 the defendant 30 is asked to review all of the case information and to indicate whether the information is correct. If the defendant 30 indicates that the information is correct, the defendant moves to step 505 which the case wizard software 147 queries the case specific database 133′ to determine what type of panel was selected by the plaintiff 20 in step 405. At this point, the defendant 30 may be informed of the type of panel selected by the plaintiff 20 and asked whether this is acceptable. If the defendant 30 desires a different panel from that selected by the plaintiff 20, the case wizard software may allow plaintiff 20 and the defendant 30 to select a panel comprised of a first number of panelists 50 meeting the plaintiff 20's criteria and a second number of panelists 50 meeting the defendant 30's criteria. Those skilled in the art will understand that a dispute handled by the system according to the present invention may comprise any number of parties. For example, where there is a single plaintiff 20 and a single defendant 30, each may select one half of the panelists 50. Where there are multiple plaintiffs 20 and/or multiple defendants 30, the panelists 50 may be apportioned equally to the plaintiffs 20 and the defendants 30 or in any other manner desired. In addition, the plaintiff 20 and the defendant 30 may discuss the type of panel they would like (using, e.g., email and/or chat) and arrive at a mutually agreeable solution.

If the panel selected is an open jury, the process is complete and the defendant 30 is advised in step 510 that the process is being submitted to the panel and provided with information including, e.g., the notice he may expect regarding a decision, and means for checking the progress of the case and the rules on deliberation. If a custom panel was selected, the case wizard software 147, in step 515 will query the defendant 30 for information regarding the characteristics of desired panelists. Once this information has been submitted, the process proceeds to step 510 and the information is stored in the corresponding case specific database 133′ and, after an editing and review process, can no longer be amended by either the defendant 30 or the plaintiff 20. If the plaintiff 20 had selected a private jury in step 405, in step 520 the case wizard software 147 asks the defendant 30 to identify a list of panelists (including the contact information of the potential panelists) that he wants to try the case or to select from a list of potential panelists 50 selected by the case wizard software 147 based on information stored in the system, a list of desired panelists 50. The process then proceeds to step 510.

Alternatively, the plaintiff 20 and the defendant 30 may be allowed to determine, e.g., whether they would like the jury deliberations to be available: 1) to the public at large; 2) only to the panelists 50 specified by the plaintiff 20 and defendant 30; or 3) selected based on the criteria specified by the plaintiff 20 and defendant 30. The varying degrees of privacy for deliberations may be achieved using methods such as chat rooms and passwords with varying degrees of access, as is known in the art.

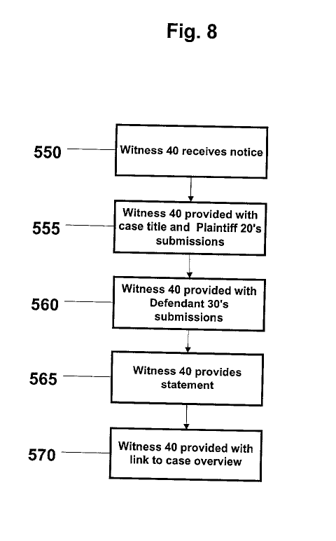

Referring to FIG. 8, when a party is named by either the plaintiff 20 or the defendant 30 as someone having information regarding the case (i.e., a witness 40), the witness 40 receives, in step 550, a communication (e.g., an email) informing him of the dispute resolution process and the rules of the proceeding and including a link which brings the witness 40 into the case. In step 555, the case wizard software provides the witness 40 with the case title, the plaintiff 20's complaint, other relevant facts and description of the current situation. Thereafter, in step 560, the case wizard software 147 provides to the witness 40 the defendant 30's response and description of the current situation along with other relevant facts. Then, in step 565 the case wizard software 147 requests through a series of questions the witness 40's statement of the facts. The witness 40 is then provided in step 570 with a link which allows the witness 40 to further discuss the case in chat rooms or in message boards.

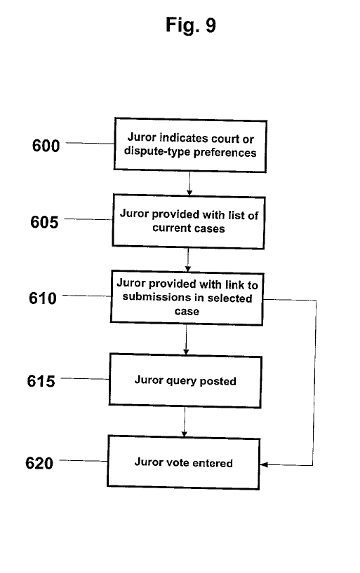

Referring to FIG. 9, in step 600 a user which indicated in step 305 of FIG. 5 that he wished to participate as a member of a jury is asked to specify in which of the available courts he would like to serve as a panelist 50. Alternatively, a potential panelist 50 may select options such as “first available proceeding,” etc. In addition, demographic and psychographic data may be collected from the potential panelist 50, which data may later be used to determine which potential panelists meet the criteria selected by plaintiff 20 and/or defendant 30 in particular dispute resolution processes. In step 605, the potential panelist 50 is presented with a the list of cases currently pending in the selected court along with links providing more information on each of the cases. In addition, those cases in which either of the parties has specified that criteria that panelists 50 must meet will be displayed to the potential panelist in a manner which indicates which of these cases the potential panelist is qualified for. After selecting a case in step 605, the potential panelist 147 is presented in step 610 with the option of reviewing all of the submissions in the selected case, submitting a query, discussing the case with other deliberating panelists 50 or voting on a decision. If the panelist 50 makes a query, this query is posted in step 615 so that it can be viewed by any participant in the case and the panelists 50 can discuss any issues raised on their own schedules. That is, panelists 50 may reply to queries or other statements from panelists 50 at a later time and need not reply when the query is first viewed. If the panelist 50 selects “vote” in step 620, the panelist 50 casts a vote for either the plaintiff 20 or the defendant 30 and the panelist 50 may continue to deliberate but will be prohibited from voting again. Of course, those skilled in the art will understand that during the registration process described above, users may be queried on a wide range of subjects in order to obtain information which may help to determine their fitness to serve on panels or juries where particular expertise is required. Of course, if a case requires a panel of panelists 50 or arbitrators with an expertise unrepresented or under-represented in the pool of registered users, inquiries may be made via, for example, a mass email to registered users requesting referrals to qualified people.

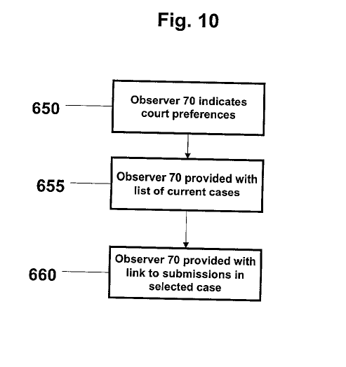

Referring to FIG. 10, in step 650 a user which indicated in step 305 of FIG. 5 that he wished to participate as an observer 70, or who did not qualify as a panelist or panelist 50 for one reason or another, is asked to specify in which of the available courts he would like to observe proceedings. Alternatively, an observer 70 may be asked to specify a type of subject matter or an identity of a party. The case wizard software 147 will then search for cases matching the specified criteria and present to the observer 70 additional information (or links to the additional information) on matching cases. In step 655, the observer 70 is presented with a list of cases currently pending in the selected court, e.g., along with links providing more information on each of the cases. After selecting a case in step 660, the observer 70 is presented with the option of reviewing all of the submissions in the selected case. Of course, those skilled in the art will understand that any of the parties (e.g., plaintiff 20 and defendant 30) may specify that a particular dispute resolution proceeding be closed so that submissions are not available to observers 70 and/or to all users not qualified to serve as panelists 50 in the dispute resolution proceeding.

The template database 137 described above, may be in the form of a data file comprised of templates for documentation required at corresponding steps in the dispute resolution process with each template including a predefined set of fields, analogous, for example, to forms used in data gathering by attorneys in similar processes. As described above, the templates may include files for pleadings such as a complaint and an answer as well as templates for registration, the listing of witnesses, selection of the pertinent law, and for motions requesting the disposition of the case or requesting rulings on selected issues. In addition, templates may be included providing admissions and requests for admissions, requests for information from witnesses and other parties, and motions for the exclusion or admission of evidence with these issues being decided by the jury 50 or other determining body. Furthermore, the templates in the template database 137 may vary based on the type of case involved. The template database 137 is secure and can only be accessed by the processor at the request of a user, such as plaintiff 20, defendant 30 or witness 40 and may, for example, provide template files in hyper text mark-up language (“html”).

Each case specific database 133′ stores information for a particular dispute resolution process concerning the parties, such as the plaintiff 20, the defendant 30, and/or the witnesses 40 as well as information on the type of dispute involved. Information added to the templates provided to the parties by the case wizard software 147 may be added to the particular case specific database 133′ to supplement the data therein as the case proceeds. Further to the description above, the search engine 157 automatically queries the template database 137 for the particular template needed at any given time as directed by the timing and sequence data selected by the case wizard software 147, e.g., a court selection template. Once this template is found, the processor 115 sends the court selection template to the plaintiff 20 who views the template right on the web page in html format. The plaintiff 20 inputs data into the court selection template using, e.g., a keyboard and a mouse.

Furthermore, participants in these proceedings may check the status of a previously initiated dispute resolution proceeding at any time after the defendant 30 has answered the complaint and this answer has been stored in the corresponding case specific database 133′. For example, after the complaint has been submitted and confirmed, a plaintiff 20 may receive an e-mail notification that the defendant 30 has responded with an answer. Plaintiff 20 may then request defendant 30's answer by, e.g., accessing the server 10 and making a request to the case wizard software 147. Alternatively, a copy of the answer may be forwarded directly to the plaintiff 20, e.g., via email. The search engine 157 then contacts the case specific database 133′ to obtain the defendant 30's answer and includes in an email to the plaintiff 20 a link to an appropriate web page. Any of the parties may also check, for example, the status of jury deliberations and the voting after the defendant 30's answer has been completed and reviewed. If the jury deliberation and voting has already ended, the inquiring party will be directed to the results page. If not, the inquiring party will be informed that the jury has not finished deliberating and voting.

Those skilled in the art will recognize that there are many modifications which may be made to the described embodiment without departing from the teaching of the invention the scope of which is intended to be limited only by the claims appended hereto. For example, the preferred embodiment of this system has been described without regard to whether decisions in this forum are binding or non-binding. Those of skilled in the art will understand that such a system may be employed strictly for entertainment purposes with results that are completely non-binding on the parties. However, there is also no reason why the parties could not agree to be bound by the decisions of this system by signing a simple contract. Furthermore, as described above the system may be modified to more closely resemble any number of dispute resolution processes including, for example, civil or criminal trial processes of other countries, arbitrations, mediations, etc.

What is claimed is:

1. A method for dispute resolution comprising the steps of:
receiving on a server a plurality of users connected to the server via a communications network;
engaging, upon notification of a dispute by a first one of the users, software guiding the first user through procedures for initiating the dispute resolution process, wherein the software gathers plaintiff information from the first user corresponding to the dispute;
receiving from the first user a first proposed rule governing behavior in situations corresponding to the dispute;
notifying a second one of the users identified by the first user as a party to the dispute of the initiation of the dispute resolution process;
soliciting from the second user defendant data corresponding to the dispute and one of a second proposed rule governing behavior in situations corresponding to the dispute and proposed modifications to the first proposed rule; and
determining a result of the dispute resolution process based upon one of the plaintiff data, the defendant data, and one of the first proposed rule, the second proposed rule and the proposed modifications to the first rule.

2. The method according to claim 1, further comprising the step of enlisting a third one of the users to determine the result of the dispute resolution process.

3. The method according to claim 1, further comprising the steps of:
soliciting registration of each of the plurality of users with the server, wherein registration includes a provision of preselected data to the server; and
excluding from participation in dispute resolution processes, unregistered users.

4. The method according to claim 1, wherein the software prompts the first user for witness contact information and uses the witness contact information and prestored data to prepare a notice to the witness of the initiation of the dispute resolution process.

5. A system for resolving disputes, comprising:
a server accessible to a plurality of users via a communications network, the server including a processor executing case management software upon notification of a dispute by a first one of the users, the case management software guiding the first user through procedures for initiating the dispute resolution process, wherein the case management software gathers plaintiff information from the first user corresponding to the dispute and receives from the first user a first proposed rule governing behavior in situations corresponding to the dispute; and
a communications arrangement notifying a second one of the users identified by the first user as a party to the dispute of the initiation of the dispute resolution process and soliciting from the second user defendant data corresponding to the dispute and one of a second proposed rule governing behavior in situations corresponding to the dispute and proposed comments on the first proposed rule, the communications arrangement providing a forum through which one or more of the plurality of users may adjudicate the dispute based upon the plaintiff data, the defendant data and one of the first proposed rule, the second proposed rule and the proposed modifications to the first rule.

6. The system according to claim 5, wherein the server requires each of the plurality of users, prior to participating in a dispute resolution process, to be registered with the server by providing preselected data to the server.

7. The system according to claim 5, wherein the case management software guides the first user through a dispute initiation process requesting data required to initiate the dispute and providing the data to the second user.

8. The system according to claim 7, wherein the case management software prompts the first user for witness contact information and uses the witness contact information and prestored data to prepare a notice to the witness of the initiation of the dispute resolution process.

9. The system according to claim 7, wherein the case management software guides the second user through an answer process requesting data required to answer the dispute initiation process initiated by the first user and provides the data to the first user.

10. A software package for resolving disputes, comprising:
a case management module guiding a plaintiff user through procedures for initiating a dispute resolution process, wherein the case management module gathers plaintiff information from the plaintiff user corresponding to the dispute and receives from the plaintiff a first proposed rule governing behavior in situations corresponding to the dispute and soliciting from a defendant user defendant data corresponding to the dispute and one of a second proposed rule governing behavior in situations corresponding to the dispute and comments on the first proposed rule; and
a deciding module providing a forum through which one or more panelist users may adjudicate the dispute based upon the plaintiff data, the defendant data and one of the first proposed rule, the second proposed rule and the proposed modifications to the first rule.

11. The software package according to claim 10, wherein the result determined by the panelist users is non-binding on the plaintiff and defendant users.

12. The software package according to claim 10, wherein the case management module is capable of initiating a dispute resolution process involving a plurality of plaintiff users and a plurality of defendant users.

13. The software package according to claim 10, further comprising an information gathering module receiving from at least one of the plaintiff and defendant users information corresponding to a witness having witness information relevant to the dispute and gathering the witness information, wherein the deciding module provides the witness information to the additional users.

14. The software package according to claim 10, further comprising a panelist evaluation module comparing one of demographic and psychographic data for potential panelist users criteria to qualify as a panelist in a particular dispute resolution process to determine which potential panelists are qualified to serve as panelists in the dispute resolution process.

15. The software package according to claim 14, wherein the panelist evaluation module allows only potential panelists who are qualified as panelists in a particular dispute resolution process to view the submissions in the particular dispute resolution process.

16. The software package according to claim 14, wherein the panelist evaluation module receives data from one of the plaintiff user and the defendant user corresponding to criteria to be applied in determining which potential panelists are to be qualified panelists in a particular dispute resolution process.
